(19) United States
(12) Patent Application Publication
(10) Pub. No.: US 2025/0184857 A1
(43) Pub. Date: Jun. 5, 2025

(54) ROUTE SELECTION IN A WIRELESS COMMUNICATION SYSTEM

(71) Applicant: InterDigital Patent Holdings, Inc., Wilmington, DE (US)

(72) Inventors: Ulises Olvera-Hernandez, Saint-Lazare (CA); Morteza Kheirkhah, London (GB); Achref Methenni, Montreal (CA); Guanzhou Wang, Brossard (CA)

(73) Assignee: InterDigital Patent Holdings, Inc., Wilmington, DE (US)

(21) Appl. No.: 18/852,377

(22) PCT Filed: Mar. 27, 2023
(86) PCT No.: PCT/US2023/016358

§ 371 Date: Sep. 27, 2024

Related U.S. Application Data
(60) Provisional application No. 63/324,330, filed on Mar. 28, 2022.

(51) Int. Cl. H04W 40/12

(52) U.S. Cl. CPC H04W 40/12

(57) ABSTRACT

Described herein are systems, methods and instrumentalities associated with route selection for a wireless transmit/receive unit (WTRU), e.g., in association with an artificial intelligence machine learning (AIML) operation of the WTRU. An application function may provide guidance for determining a data network and a network slice for carrying out the AIML operation of the WTRU. The guidance may be provided through one or more route selection rules, based on which the WTRU may perform a protocol data unit (PDU) session modification triggered by a change of conditions (e.g., location) at the WTRU.

### CROSS-REFERENCE TO RELATED APPLICATIONS

This application claims the benefits of U.S. Provisional Patent Application No. 63/324,330, filed Mar. 28, 2022, the contents of which are incorporated by reference herein.

### BACKGROUND

Data and control information such as that associated with artificial intelligence machine learning (AIML) applications or tasks may be carried in a wireless communication system such as a fifth generation (5G) new radio (NR) system. To facilitate the transmission or reception of such information, constraints (e.g., architectural assumptions) may be imposed on the communication system, and existing traffic routing mechanisms may be re-used, re-purposed and/or enhanced to support the AIML applications or tasks.

### SUMMARY

Disclosed herein are systems, methods, and instrumentalities associated with route selection in a wireless communication network. A wireless transmit/receive unit (WTRU) in accordance with embodiments of the present disclosure may include a processor configured to receive route selection policy information from a network device, where the route selection policy information may indicate at least a first data network, a second data network, a network slice for the WTRU to connect to the first data network or the second data network, and a criterion associated with route selection. The processor may be further configured to determine an existing protocol data unit (PDU) session associated with the first data network that may be established using the network slice indicated by the route selection policy information, determine, based at least on a location of the WTRU and the route selection policy information, that the second data network may satisfy the criterion associated with route selection, and transmit a PDU session modification request (e.g., to the network device) indicating that the existing PDU session is to be associated with the second data network (e.g., using the same network slice indicated by the route selection policy information and/or by changing a destination of the existing PDU session to a device associated with the second data network).

In examples, the processor of the WTRU may be configured to, prior to the transmission of the PDU session modification request, perform a first artificial intelligence machine learning (AIML) operation using the existing PDU session. After the transmission of the PDU session modification request, the processor may be configured to receive a response indicating that the existing PDU session has been modified (e.g., connected with a device in the second data network) and to perform a second AIML operation using the modified PDU session.

In examples, the criterion provided in the route selection policy information may be a mapping between an AIML operation and a data network, a mapping between a location and a data network, and/or at least one of a latency level, a network congestion level, or a quality of service level. In examples, the processor of the WTRU may be further configured to receive analytics associated with the WTRU from the network device and determine that the second data network satisfies the criterion indicated in the route selection policy information further based on the received analytics.

In examples, at least one of the first AIML operation or the second AIML operation may be associated with federated learning, while the route selection policy information may include a first route selection descriptor (RSD) indicating a data network name (DNN) of the first data network and a second RSD indicating a DNN of the second data network.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example of modifying a PDU session to support an operation (e.g., such as an AIML operation) of a WTRU.

FIG. 3 is a diagram illustrating an example of information exchange between a WTRU and one or more network devices or entities.

### DETAILED DESCRIPTION

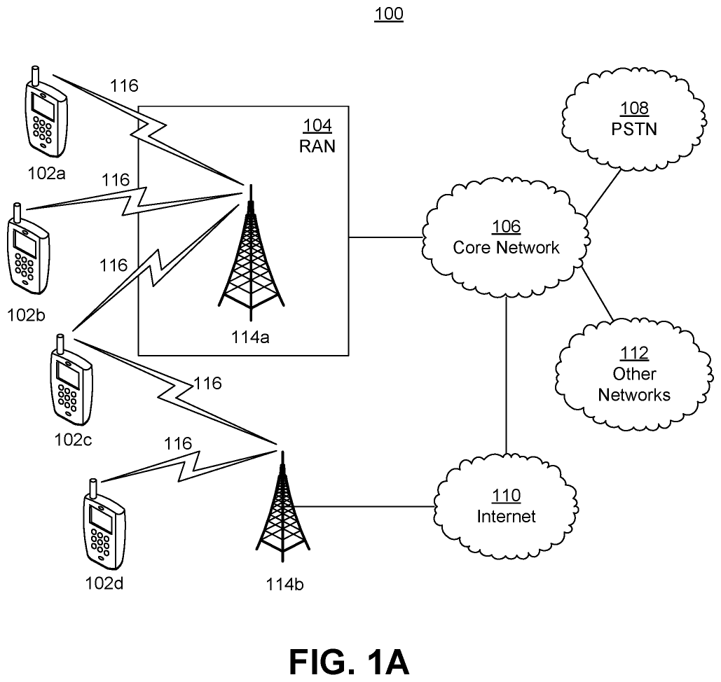

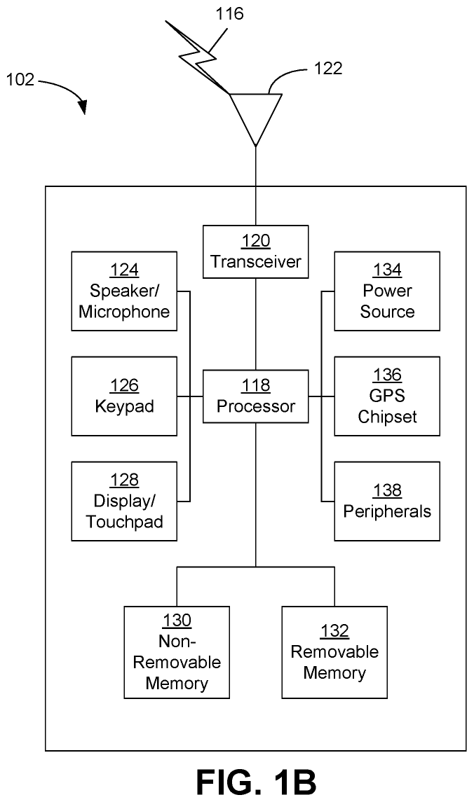

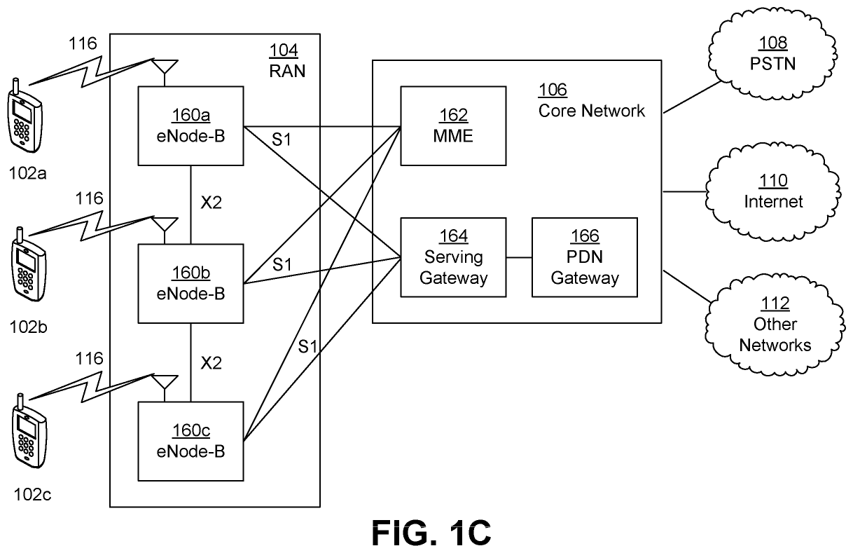

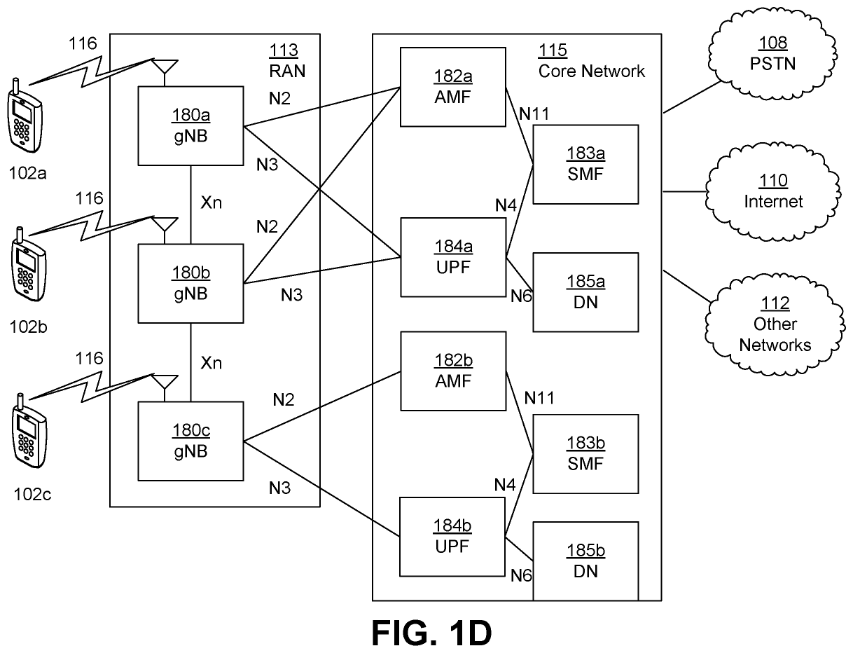

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHZ channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHz, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The functionalities and/or features of a wireless communication system as described herein may be enhanced, re-purposed, or re-used to support additional traffic types such as AIML application (e.g., federated learning) traffic. For example, an application function (AF) may be configured to provide guidance (e.g., regarding geographical locations or zones, AF identifiers, latency requirements, quality of service (QOS) criteria, etc.) to devices (e.g., WTRUs) in the wireless communication system to enable the devices to set up and implement user equipment route selection policy (URSP) rules. Such URSP rules may include, for example, rules for determining a network slice (e.g., represented by single network slice selection assistance information (S-NSSAI), a data network (e.g., represented by a data network name (DNN)), an AF instance, a protocol data unit (PDU) session, an edge application server (EAS), etc. that may be used by the devices to carry out their functions (e.g., AIML operations) under various conditions.

Examples may be described herein in the context of AIML operations, but those skilled in the art will appreciate that techniques disclosed in these examples may also be employed to perform other types of operations.

An AIML operation and/or its associated AF may be served by a network slice (e.g., a single network slice). If the AF is available in multiple locations (e.g., through edge computing), an instance of the AF (e.g., implemented on an EAS) may be suitable (e.g., more suitable than other AF instances) for one or more specific AIML operations and/or one or more specific locations. For example, if an AF instance (e.g., running on an EAS) may provide reduced latency for a federated learning operation (e.g., an example of the AIML operation described herein), a WTRU may select the AF instance and move (e.g., re-direct) ALML traffic towards that AF instance (e.g., to the data network or EAS associated with the AF instance). The AF and/or a network device (e.g., a core network device or function) may provide guidance to the WTRU to facilitate the transition to the AF instance. The guidance may, for example, inform the WTRU about the AF instance as the WTRU moves into the vicinity of the AF instance (e.g., as the WTRU moves from a first geographical location to a second geographical location, from an area covered by a public network to an area covered by a private network, etc.). The guidance may covey information about an S-NSSAI and/or a DNN (e.g., in the vicinity of a certain location) that the WTRU may use to establish a PDU session (e.g., for carrying out an AIML operation). Such guidance may be provided to the WTRU at various times including, for example, during an initial configuration procedure (e.g., during WTRU registration), via periodic configuration updates (e.g., in a non access stratum (NAS) and/or radio resource control (RRC) message), as the WTRU transitions from a current AF (e.g., since the AF may no longer support the AIML operation of the WTRU) to a different AF, etc.

URSP mechanisms and/or rules may be implemented to facilitate the operation (e.g., AIML operation) of a wireless communication network (e.g., to direct AIML operation traffic to a certain network slice and/or data network that may provide better support for the AIML operation). Guidance may be provided to enable an association or mapping of AIML contexts (e.g., characterized by location, time, DNN, and/or S-NSSA) with the traffic characteristics of the AIML operation (e.g., as indicated by an application descriptor that may indicate the operation type, latency requirements, QoS requirements, etc. of the AIML operation). The guidance may be provided to a policy control function (PCF) of the wireless communication network and/or used to set URSP rules. These URSP rules may include information (e.g., filtering information) that may associate a data network (e.g., represented by a DNN), a network slice (e.g., represented S-NSSAI), a fully qualified domain name (FQDN), a geographical location, a time of the day (e.g., the time when one or more other applications are also running), etc. with certain AIML operations of a WTRU or a group of WTRUs. For example, the association may limit traffic related to specific AIML operations of the WTRU(s) to the S-NSSAI, DNN, geographical location, and/or time of the day indicated by the URSP rules. The association may serve as a criterion (e.g., route selection criterion) for the WTRU(s) to determine which DNN and/or network slice to use for an AIML operation at a location and/or time of the day (e.g., the WTRU(s) may switch from performing an AIML operation over a first DNN or PDU session to performing the AIML operation over a second DNN or PDU session if the WTRU(s) moves to a location near the second DNN).

The group of WTRUs for which the guidance or USRP rules may be provided may include a group of WTRUs that may be part of a federated learning operation or a distributed AIML operation such as an image recognition operation. The AIML operations described herein may be associated with respective AIML operation types and/or traffic or service descriptors (e.g., a combination of operation system ID (OSid), application ID, and DNN). As such, the guidance or USRP rules may indicate an AF service identifier (e.g., using a data element such as AF-Service_Identifier), an AIML operation type, and/or a traffic or service descriptor associated with the guidance or USRP rules, and a WTRU may determine which specific AIML operations may be subject to the guidance or USRP rules based on the indication. In examples, an AIML operation type may be mapped (e.g., by a PCF or a network exposure function (NEF)) to a traffic or service descriptor, and one or multiple combinations of service descriptors and AIML operation types may be associated with a set of route selection parameters. The PCF may determine the precedence (e.g., an order in which a WTRU may apply route selection rules) for a specific service descriptor based on the AIML operations associated with that descriptor. A WTRU may use the precedence information when applying route selection rules.

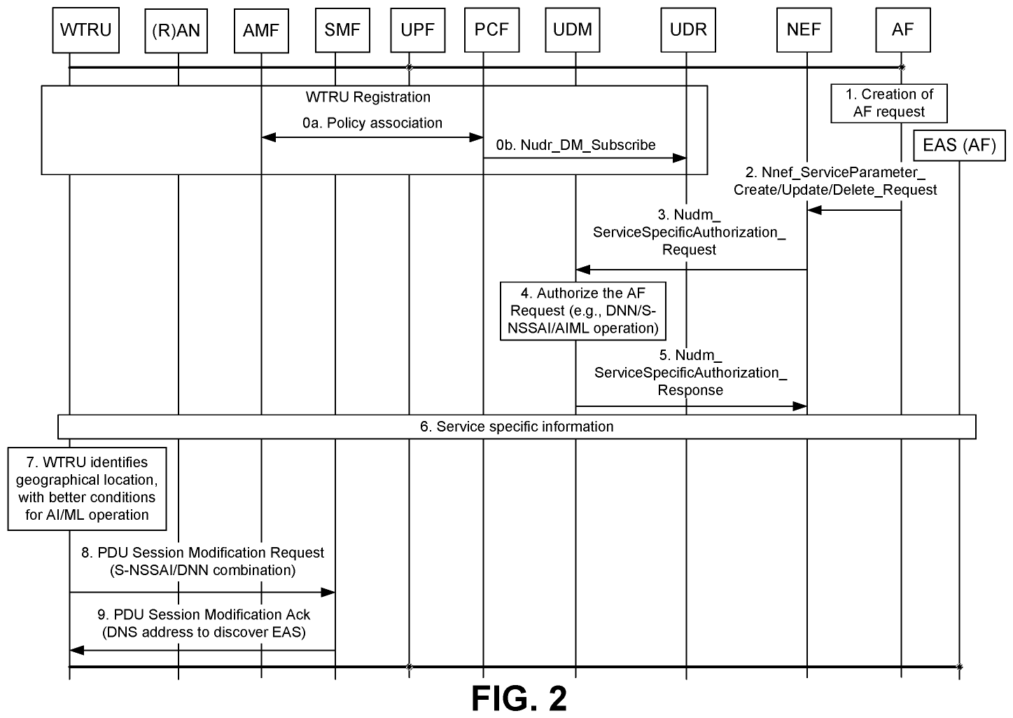

FIG. 2 illustrates an example of modifying an existing PDU session (e.g., associated with an AIML operation) in accordance with embodiments of the present disclosure. As shown in FIG. 2, a WTRU may, at 0a and 0b, may register with a network (e.g., a core network). At 1 and 2, an AF may generate an AF request (e.g., a service parameter request) in which the AF may provide guidance for one or more operations (e.g., AIML operations) of the WTRU (or a group of WTRUs). The guidance may include information regarding the one or more operations (e.g., operation type, application or service descriptor, etc.), information regarding network slice(s) and/or data network(s) associated with the operations, and/or information regarding an association of a network slice (e.g., represented by S-NSSAI), a data network (e.g., represented by a DNN), an FQDN, a location, a time of the day, and/or the like with an AIML operation or operation type. The guidance may also include service parameters that may enable a core network to update policies (e.g., URSP rules) for the WTRU.

At 3-5, a network function such as the NEF may request (e.g., from a unified data manager (UDM)) a service authorization for the one or more operations of the WTRU (e.g., by transmitting a Nudm_ServiceSpecificAuthrization_Request to the UDM), and the NEF may receive a response (e.g., a Nudm_ServiceSpecificAuthrization_Response from the UDM) after the authorization is granted. For example, at 3, the NEF may (e.g., if the AF is not already authorized) send a request to the UDM to authorize the guidance provided by the AF. In response to such a request, the UDM may, at 4, verify that the guidance provided by the AF can be converted to one or more URSP rules in a manner that is consistent with the WTRU's subscription (e.g., a DNN and S-NSAAI combination for an AIML operation or operation type is valid based on the WTRU's subscription information). The UDM may perform the verification, for example, by considering the relevant AIML operation(s), application traffic descriptor(s), route selection parameter(s) (e.g., DNN, S-NSSAI, session and service continuity (SSC) mode, etc.), and spatial validity condition(s) against the subscriber record of the WTRU.

If the UDM authorizes the request at 4 (e.g., some requests related to the AIML operation(s) may be accepted while others may be rejected), the UDM may indicate the authorization decision to the NEF at 5, and the NEF may, in response, make one or more URSP rules related to the AIML operation(s) of the WTRU based on the guidance provided by the AF. Such USRP rules may include, for example, one or more route selection descriptors (RSDs) (e.g., a first RSD and a second RSD) that may indicate respective data networks (e.g., a first data network and a second data network) associated with the AIML operation(s) of the WTRU. The USRP rules (e.g., the RSDs included in the rules) may also indicate a network slice that the WTRU may use to connect to the data networks (e.g., to the first data network and/or the second data network) and/or a criterion that the WTRU may use for route selection (e.g., a condition or trigger for the WTRU to switch from a first data network to a second data network). For example, the criterion may indicate one or more of a desired latency level associated with an AIML operation of the WTRU, a desired congestion level associated with the AIML operation of the WTRU, a desired QoS level associated with the AIML operation of the WTRU, a mapping between a location and data network, a mapping between the AIML operation and a data network, and/or the like.

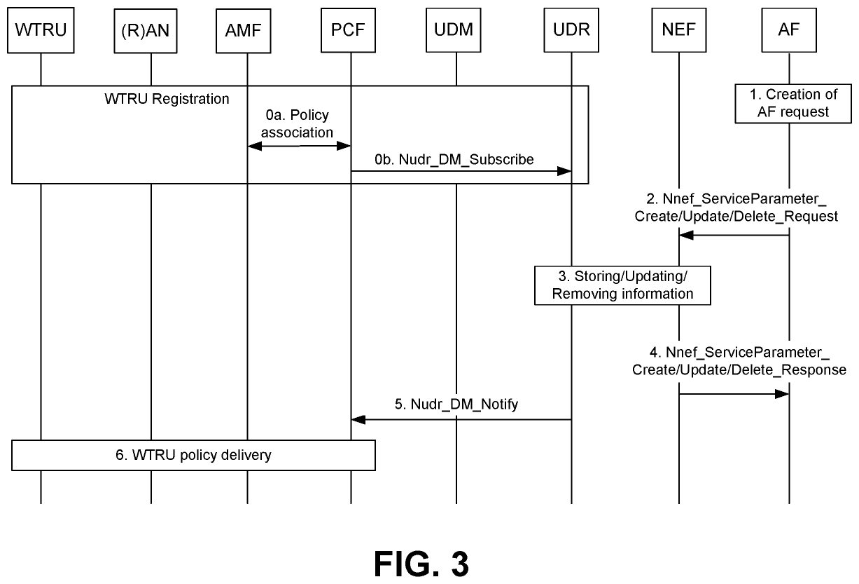

Still referring to FIG. 2, service or operation specific information such as the URSP rules described herein may be exchanged at 6 between the WTRU (or a group of WTRUs), one or more network functions or devices, and/or the AF (e.g., based on operations described below with reference to FIG. 3). At 7, the WTRU may determine, based at least on the URSP rules received by the WTRU (e.g., which may include information regarding spatial conditions such as locations under which the URSP rules may be valid) and/or a condition at the WTRU (e.g., a location of the WTRU), that an operation of the WTRU may be served (e.g., better served) by a certain AF instance, network slice, and/or data network. For example, the WTRU may have been performing a first set of one or more AIML operations via an existing PDU session (e.g., a first PDU session) that may have been established with a first data network (e.g., associated with a first AF instance and represented by a first DNN) through a certain network slice and, as the WTRU moves a different location, the WTRU may determine, based on the URSP rules provided by the network and the location of the WTRU, that a second data network (e.g., for a second AF instance running on an EAS close to the WTRU's new location) may satisfy the route selection criterion indicated by the URSP rules (e.g., the criterion may indicate a mapping between location of the WTRU and the second data network, or a mapping between a second set of AIML operation(s) and the second data network). Based on such a determination, the WTRU may, at 8, transmit a PDU session modification request (e.g., to a core network function via an access network such as a base station) to associate the existing PDU session (e.g., the first PDU session) with the second data network (e.g., represented by a second DNN). The WTRU may do so, for example, by indicating in the PDU session modification request that a destination of the existing PDU session is to be changed to a device (e.g., an edge server) associated with the second data network. The WTRU may include information about the second data network in the PDU session modification request. For example, the WTRU may indicate a DNN/S-NSSI combination in the PDU session modification request such that the existing PDU session may be modified to use the second DNN and the same network slice that was used to establish the existing PDU session (e.g., the DNN for an AIML operation may change, but the network slice for the AIML operation may remain unchanged).

In examples, the WTRU may, at 8, set up a new PDU session with the second data network (e.g., instead of modifying the existing PDU session towards that second data network). As described herein, the WTRU may obtain information about the second AF instance, the second data network associated with the second AF instance, and/or the network slice that may be used to connect to the second data network based on the URSP rules provided by the network (e.g., delivered by the PCF). As described herein, while the WTRU may switch to a different data network for an AIML operation, the WTRU may continue to use the same network slice (e.g., S-NSSAI) for that AIML operation. In examples, the WTRU may maintain the existing PDU session (e.g., currently with the new PDU session).

In examples, the WTRU may also subscribe to analytics (e.g., mobility analytics) that may be provided by the core network and may use the analytics received from the network (e.g., in conjunction with the URSP rules) to determine which AF instance or data network to use and/or when to switch to that AF instance or data network. The WTRU may make these determinations, for example, based on congestion information that may be derived from slice load analytics and/or user data analytics.

In either of the scenarios described herein (e.g., modifying an existing PDU session for the AIML operation or creating a new PDU session for the AIML operation), the WTRU may, at 9, receive an acknowledgment granting or denying the PDU session modification request or the PDU session establishment request sent by the WTRU. For example, a modification of the DNN/S-NSSAI combination indicated by the WTRU may trigger the network to provide a new DNS server address (e.g., if the network decides to grant the modification request), and the WTRU may locate an edge application server (EAS) through the DNS server and connect to the EAS to perform the second set of AIML operation(s) described herein.

FIG. 3 illustrates an example of service specific parameter provisioning that may be performed, e.g., as part of 6 of FIG. 2. As shown in the example, an AF may create an AF request at 1, e.g., by involving a Nnef_ServiceParameter_Create service operation, an Nnef_ServiceParameter_Update operation, or a Nnef_ServiceParameter_Delete service operation. At 2, the AF may send its request to the NEF. If the NEF authorizes the AF request, the NEF may, at 3, store the AF request information in a unified data repository (UDR). In the case of Nnef_ServiceParameter_Delete, the NEF may remove the AF request information from the UDR. At 4, the NEF may respond to the AF with a status of the AF request and/or a transaction ID associated with the AF request. At 5, the PCF may receive a Nudr_DM_Notify notification of data change from the UDR and the PCF may, at 6, initiate a policy delivery to the WTRU at 6.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-27. (canceled)

28. A wireless transmit/receive unit (WTRU), comprising:
a processor configured to:
receive route selection policy information from a network device, wherein the route selection policy information indicates at least a first data network, a second data network, a network slice for the WTRU to connect to the first data network and the second data network, and a criterion associated with route selection;
determine an existing protocol data unit (PDU) session associated with the first data network, wherein the existing PDU is established using the network slice indicated by the route selection policy information;
determine, based at least on a location of the WTRU and the route selection policy information, that the second data network satisfies the criterion associated with route selection; and
transmit a PDU session modification request, wherein the PDU session modification request indicates that the existing PDU session is to be associated with the second data network.

29. The WTRU of claim 28, wherein the PDU session modification request indicates that a destination of the existing PDU session is to be changed to a device associated with the second data network.

30. The WTRU of claim 28, wherein, prior to the transmission of the PDU session modification request, the processor is further configured to perform a first artificial intelligence machine learning (AIML) operation via the existing PDU session.

31. The WTRU of claim 30, wherein, after the transmission of the PDU session modification request, the processor is further configured to receive a response indicating that the existing PDU session has been modified and to perform a second AIML operation via the modified PDU session.

32. The WTRU of claim 31, wherein the criterion associated with route selection indicates a mapping between the second AIML operation and the second data network.

33. The WTRU of claim 31, wherein at least one of the first AIML operation or the second AIML operation is associated with federated learning.

34. The WTRU of claim 28, wherein the criterion associated with route selection indicates a mapping between the location of the WTRU and the second data network.

35. The WTRU of claim 28, wherein the criterion associated with route selection indicates a latency level, a network congestion level, or a quality of service level.

36. The WTRU of claim 28, wherein the processor is further configured to receive analytics associated with the WTRU from the network device and determine that the second data network satisfies the criterion associated with route selection based further on the received analytics.

37. The WTRU of claim 28, wherein the route selection policy information includes a first route selection descriptor (RSD) that indicates a data network name (DNN) of the first data network, the route selection policy information further including a second RSD that indicates a DNN of the second data network.

38. A method implemented by a wireless transmit/receive unit (WTRU), the method comprising:
receiving route selection policy information from a network device, wherein the route selection policy information indicates at least a first data network, a second data network, a network slice for the WTRU to connect to the first data network and the second data network, and a criterion associated with route selection;
determining an existing protocol data unit (PDU) session associated with the first data network, wherein the existing PDU is established using the network slice indicated by the route selection policy information;
determining, based at least on a location of the WTRU and the route selection policy information, that the second data network satisfies the criterion associated with route selection; and
transmitting a PDU session modification request, wherein the PDU session modification request indicates that the existing PDU session is to be associated with the second data network.

39. The method of claim 38, wherein the PDU session modification request indicates that a destination of the existing PDU session is to be changed to a device associated with the second data network.

40. The method of claim 38, further comprising, prior to transmitting the PDU session modification request, performing a first artificial intelligence machine learning (AIML) operation via the existing PDU session.

41. The method of claim 38, further comprising, after transmitting the PDU session modification request, receiving a response indicating that the existing PDU session has been modified and performing a second AIML operation via the modified PDU session.

42. The method of claim 41, wherein the criterion associated with route selection indicates a mapping between the second AIML operation and the second data network.

43. The method of claim 38, wherein the criterion associated with route selection indicates one or more of a mapping between the location of the WTRU and the second data network, a latency level, a network congestion level, or a quality of service level.

44. The method of claim 38, further comprising receiving analytics associated with the WTRU from the network device, wherein the second data network is determined to satisfy the criterion associated with route selection further based on the received analytics.

45. The method of claim 38, wherein the route selection policy information includes a first route selection descriptor (RSD) that indicates a data network name (DNN) of the first data network, the route selection policy information further including a second RSD that indicates a DNN of the second data network.

46. A network device, comprising:
a processor configured to:
transmit route selection policy information to a wireless transmit/receive unit (WTRU), wherein the route selection policy information indicates at least a first data network, a second data network, a network slice for the WTRU to connect to the first data network and the second data network, and a criterion associated with route selection by the WTRU;
receive a protocol data unit (PDU) session modification request from the WTRU, wherein the PDU session modification request is associated with an existing PDU session of the WTRU established with the first data network via the network slice indicated by the route selection policy information, and wherein the PDU session modification request includes information regarding the network slice and an indication that the existing PDU session is to be associated with the second data network; and
transmit a PDU session modification response to the WTRU, wherein the PDU session modification response indicates whether the PDU session modification request has been granted or denied.

47. The network device of claim 46, wherein the processor is further configured to determine the route selection policy information based on guidance received from an application function that is associated with an artificial intelligence machine learning (AIML) operation of the WTRU.
